(19) United States
(12) Patent Application Publication
(10) Pub. No.: US 2008/0252926 A1
(43) Pub. Date: Oct. 16, 2008

(54) Image Scanning Device

(75) Inventor: Katsushi MINAMINO, Kyoto-shi (JP)

Correspondence Address: HOGAN & HARTSON L.L.P., 1999 AVENUE OF THE STARS, SUITE 1400, LOS ANGELES, CA, 90067, US

(73) Assignee: MURATA MACHINERY, LTD., Kyoto-shi (JP)

(21) Appl. No.: 12/100,324

(22) Filed: Apr. 9, 2008

(30) Foreign Application Priority Data
Apr. 16, 2007 (JP) 2007-107451

(51) Int. Cl. G06K 15/00

(52) U.S. Cl. 358/1.15

(57) ABSTRACT

A method for determining whether or not a specific image is contained in a scanned image. An image on a first side of a document is scanned and first image information indicating the scanned image is outputted. Specific component information is extracted indicating a specific component of each pixel out of information indicating a pixel value contained in the first image information. Whether or not the specific image is contained in the image on the first side is determined based on the extracted specific component information and stored specific image information.

### CROSS-REFERENCE TO RELATED APPLICATIONS

This application claims priority under 35 U.S.C. 119 to Japanese Patent Application No. 2007-107451, filed on Apr. 16, 2007, which application is hereby incorporated by reference in its entirety.

### BACKGROUND OF THE INVENTION

1. Field of the Invention

The present invention relates to image scanning devices for determining whether or not a specific image is contained on both sides of a document, in particular, to an image scanning device for scanning images on both sides of a document with different scanning parts for each side, and determining whether or not the specific image is contained in the scanned image.

2. Description of the Related Art

An image scanning device is a device, included in a scanner, for scanning an image of a document. The scanner may be included in a facsimile, a copy machine, or a multifunction peripheral thereof.

Some documents such as paper money are preferably not copied. In the image scanning device, control is performed so that processing of a specific image (hereinafter referred to as “specific image”) contained in the document that is prohibited from being copied cannot be carried out. One example of such a specific image is a seal marked on paper money. The image scanning device includes a circuit substrate as a specific image determining part for determining whether or not a specific image such as a seal of paper money is contained in the document. Fraud and crime can be prevented by prohibiting processing of a document determined to contain the specific image by the specific image determining part.

Many image scanning devices scan images on both sides of a document. Such an image scanning device scans the front side and the back side of the document with two different scanning parts. When scanning both sides of a document supplied with an ADF (Auto Document Feeder), a first scanning part of a CIS (Contact Image Sensor; contact-type sensor) type is included in a document pressing unit including the ADF (hereinafter also referred to as “ADF unit”), and a second scanning part of a CCD (Charge Coupled Devices; also referred to as reduction optical system, optical reduction type, etc.) type is included in a body unit including an FBS (Flat Bed Scanner) (hereinafter also referred to as “FBS unit”). Both sides of the document can then be scanned while passing just once through a document transportation path in the ADF.

A method of determining whether or not the specific image is contained in both the image on the front side and the image on the back side is known to prevent fraud and crime, but if the circuit substrate serving as the specific image determining part is included in both the first scanning part of the document pressing unit and the second scanning part included in the body unit, the entire image scanning device becomes complicated and the cost becomes high. The presence of the specific image is desirably determined with one specific image determining part.

A technique of reducing an input image on the front side and the back side to synthesize one image, and inputting the same to the specific image determining part has been proposed. Whether the specific image is contained on both sides of the document can then be determined with one specific image determining part included in the image scanning device.

However, since the first scanning part included in the document pressing unit and the second scanning part included in the body unit respectively scan the image of the document and output the image as image information configured by three components in the conventional image scanning device, there is a problem in that numerous wirings are required to transmit the image information to the specific image determining part.

For instance, when the specific image determining part is included in the body unit, the first scanning part and the specific image determining part are wire connected to transmit the image information from the first scanning part included in the document pressing unit to the specific image determining part. If the image information is represented in the RGB system in which the color tone of a pixel is expressed with luminance of the three primary colors of light, or in the YCC system in which the color tone of a pixel is expressed with luminance and color difference, the image information is configured by three components in either case, and each component has eight bits. The number of wirings for connecting the first scanning part and the specific image determining part is thus twenty-four.

Furthermore, a wiring for connecting the first scanning part and a CPU (Central Processing Unit) is generally arranged. If the processing ability of the CPU is sixteen bits, the first scanning part and the CPU are wire connected with sixteen wirings.

Thus, forty wirings are necessary to wire connect the first scanning part in the document pressing unit, and the specific image determining part and the CPU in the body unit. Generally, the document pressing unit included with the first scanning part and the body included with the specific image determining part and the CPU are freely opened/closed with a hinge structure. In such a hinge structure, the large amount of wirings required to connect the document pressing unit and the body unit is a restriction and a load in design and development.

### SUMMARY OF THE INVENTION

In view of solving the above problems, the present invention provides an image scanning device that transmits image information from a scanning part for scanning an image of a document to a specific image determining part with a small amount of wirings.

In order to overcome the problems described above, embodiments of the present invention relates to an image scanning device for scanning an image of a document, and determining whether or not a specific image is contained in the scanned image. The image scanning device includes a first scanning part for scanning an image on a first side of the document and outputting first image information indicating the scanned image. An extracting part acquires the first image information from the first scanning part and references the acquired first image information to extract specific component information indicating a specific component of each pixel out of information indicating a pixel value contained in the first image information. A specific image information storage part stores specific image information for determining the specific image. A specific image determining part acquires the extracted specific component information from the extracting part and acquires the specific image information from the specific image information storage part, and determines whether or not the specific image is contained in the image on the first side based on the acquired specific component information and the acquired specific image information.

Therefore, the specific image determining part determines whether or not the specific image is contained in the image on the first side based only on the specific component of the first image information. The extracting part for outputting the specific component of the first image information and the specific image determining part thus merely need to be connected with a wiring for transmitting/receiving the specific component of the first image information. That is, the number of signal lines configuring the wiring is reduced compared to a case where wirings for transmitting all components of the first image information to the specific image determining part are necessary. The restriction and the load in design caused by the wiring is thereby alleviated and radiation noise is reduced.

The specific component of the image information is one of the R component, the G component, or the B component of the RGB system, one of the luminance component/color difference component of the YCC system, or one of the brightness/chroma of the Lab system.

The image scanning device may further include a second scanning part for scanning an image on a second side of the document and outputting second image information indicating the scanned image. The specific image determining part further acquires the second image information from the second scanning part, and determines whether the specific image is contained on the second side of the document based on the acquired second image information and the acquired specific image information.

Thus, the specific image determining part determines whether or not the specific image is contained in the image on the second side. Whether or not the specific image is contained on each side of the document is determined with one specific image determining part. Therefore, compared to a case of including two different specific image determining parts to determine whether or not the specific image is contained in each image on each respective side, the number of specific image determining parts is reduced, the configuration of the entire device is simplified, and the cost is reduced.

The image scanning device may also include a document pressing unit attached to a body unit in a freely openable/closable manner. The document pressing unit includes the first scanning part and the extracting part. The body unit includes the specific image information storage part, the specific image determining part, and the second scanning part.

Each part of the image scanning device is arranged separated to the document pressing unit and the body unit. A wiring for connecting the extracting part and the specific image determining part is thus required, but the information transmitted/received therebetween is only the specific component information. The specific image information is just one part of the back side image information and is thus small compared to all the back side image information, and thus the number of wirings for connecting the extracting part and the specific image determining part is reduced compared to a case of transmitting/receiving all the back side image information. Therefore, the restriction and the load in design caused by the wiring is alleviated. The radiation noise is also reduced.

The image scanning device may also include a dedicated line for connecting the extracting part and the specific image determining part and transmitting the specific component information extracted by the extracting part.

Therefore, by including a dedicated line, the extracting part transmits the extracted specific component information to the specific image determining part through the dedicated line.

For instance, the uncompressed specific component information has a large volume, and if transmitted through the system bus, the system bus will be occupied and other processes will get behind. However, if the image scanning device includes the dedicated line, influence on other processes due to occupation of the system is eliminated since the system bus is not used to transmit the specific component information, thereby suppressing a lowering in process in the image scanning device.

Moreover, the occupation of the system bus is alleviated by compressing the specific component information, but the load on the process increases since a load to execute the compression and decompression processes is imposed. A processor for compression and decompression processes may be further included, but this complicates the configuration of the image scanning device. The dedicated line for transmitting the specific image information merely transmits the specific component, and the extent of complicating the configuration of the image scanning device is small compared to a case of including a processor for the compression and decompression processes.

Therefore, lowered performance and complication of the configuration of the image scanning device due to determination of the specific image is suppressed by including the dedicated line for transmitting the specific component information.

The second scanning part may have a higher resolution capability than the first scanning part.

Therefore, when the resolution capability differs between the first and second scanning parts, the second scanning part has a higher resolution capability than the first scanning part. Generally, when the same image is scanned, the amount of information of the first image information indicating the image scanned by the first scanning part having a lower resolution capability is less than the amount of information of the second image information indicating the image scanned by the second scanning part having a higher resolution capability. Thus, the specific image determining part acquires only the specific component of the first image information indicating the image scanned by the first scanning part having a lower resolution capability, so that the communication load of the wiring connecting the extracting part and the specific image determining part is reduced compared to a case of acquiring only the specific component of the second image information.

A case where the resolution capability differs between the first scanning part and the second scanning part and the second scanning part has a higher resolution capability than the first scanning part includes a case where the first scanning part is a scanning part for scanning through a contact-type sensor method, and the second scanning part is a scanning part for scanning through an optical reduction method.

The present invention is not only realized as an image scanning device equipped with such parts, but is also realized as a scanner and a network multifunction peripheral equipped with such image scanning device.

According to the present invention, the image information is transmitted from a scanning part for scanning the image of the document to the specific image determining part for determining whether or not a specific image is contained in the document with a reduced number of wirings. Therefore, the restriction and the load in design caused by the wiring is alleviated, and radiation noise from the wiring is reduced.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 is a view showing a configuration example of a communication system including a network multifunction peripheral serving as one embodiment of the present invention.

FIG. 2A is a front view of the network multifunction peripheral.

FIG. 2B is a plan view of the network multifunction peripheral.

FIG. 3 is a cross sectional view showing main parts of a scanner of the present embodiment

FIG. 4 is a view showing details of a back side scanning part of the present embodiment.

FIG. 5 is a block diagram showing one example of a hardware configuration of the network multifunction peripheral of the present embodiment.

FIG. 6 is a block diagram of a functional configuration of the scanner of the present embodiment.

FIG. 7A is a view showing a specific image of the present embodiment.

FIG. 7B is a conceptual view showing specific image information stored in a specific image storage part of the present embodiment.

FIG. 7C is a view showing one example of specific image information stored in the specific image storage part of the present embodiment.

FIG. 8 is a flowchart of a front side process executed by the image scanning device of the present invention.

FIG. 9 is a flowchart of a back side process executed by the image scanning device of the present invention.

FIG. 10A is a view showing one example of a document containing the specific image.

FIG. 10B is a view showing one example of a copy of a document containing a specific image created by the network multifunction peripheral equipped with the image scanning device of the present invention.

FIG. 11 is a view showing a display example of a display presenting that the specific image is contained in the scanned document.

### DETAILED DESCRIPTION OF PREFERRED EMBODIMENTS

An embodiment of an image scanning device according to the present invention is described below with reference to the drawings.

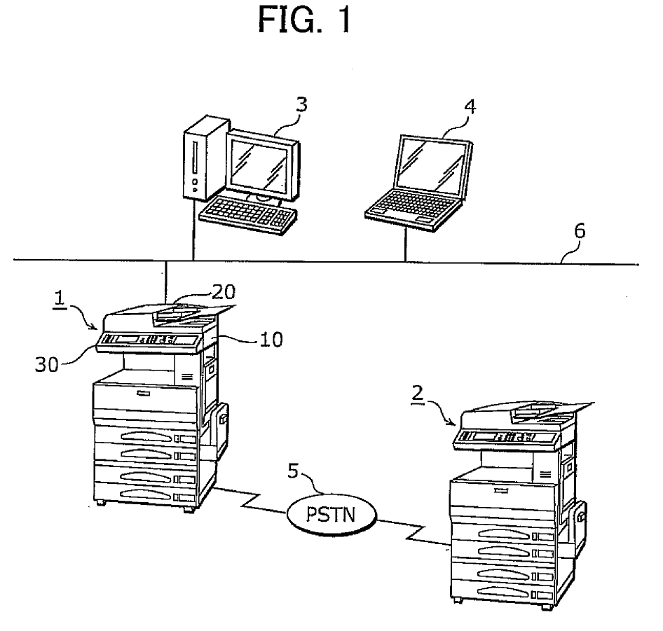

FIG. 1 is a view showing a configuration example of a communication system including a network multifunction peripheral serving as one embodiment of the present invention.

The communication system shown in FIG. 1 is configured by network multifunction peripherals 1 and 2, and terminals 3 and 4, to which the network multifunction peripherals 1 and 2 are connected through PSTN (Public Switched Telephone Networks) 5. The network multifunction peripheral 1, the terminal 3, and the terminal 4 are connected through a LAN (Local Area Network) 6.

The network multifunction peripherals 1 and 2 have printer, facsimile, LAN communication, and scanner functions. The terminals 3 and 4 are computers etc. that can perform LAN communication. The image scanning device of the present invention is included in a scanner equipped in the network multifunction peripherals 1 and 2.

For instance, the network multifunction peripheral 1 facsimile transmits information (hereinafter also referred to as “image information”) indicating an image of a document scanned with the scanner to the network multifunction peripheral 2 through the PSTN 5, or transmits the information to the terminals 3 and 4 through the LAN 6.

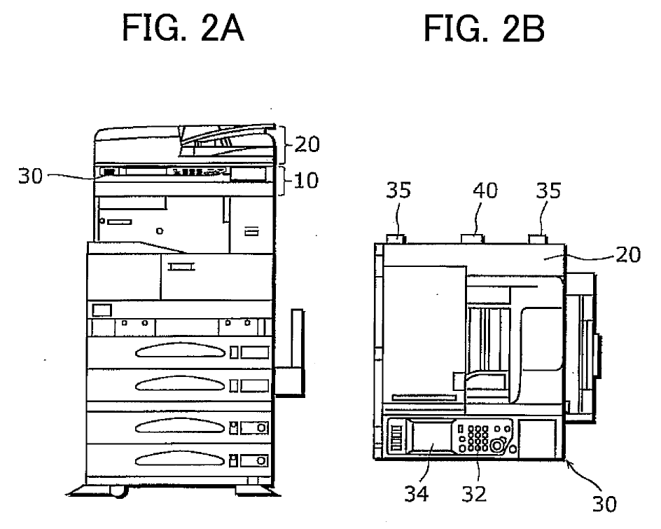

FIG. 2A is a front view and FIG. 2B is a plan view of the network multifunction peripheral 1. As shown in FIG. 2A, the network multifunction peripheral 1 includes a body unit and a document pressing unit.

The document pressing unit is a place for pressing down a document placed on a contact glass of the FBS. One example of the document pressing unit is an ADF unit 20 of the present embodiment.

The body unit is the portion other than the ADF unit 20, a hinge 35, and a wiring 40. An FBS unit 10 and a user interface 30 constitute one part of the body unit.

As shown in FIG. 2B, the ADF unit 20 is attached to the FBS unit 10 with the hinge 35, where the user interface 30 side is freely openable/closable with the hinge 35 as a shaft. That is, the FBS unit 10 and the ADF unit 20 are coupled with the hinge 35, and the circuit substrate included in each of the FBS unit 10 and the ADF unit 20 transmits/receives information through the wiring 40 formed by bundling signal lines.

The user interface 30 is integrated with the FBS unit 10, and includes an operation panel 32 and a display 34, as shown in FIG. 2B.

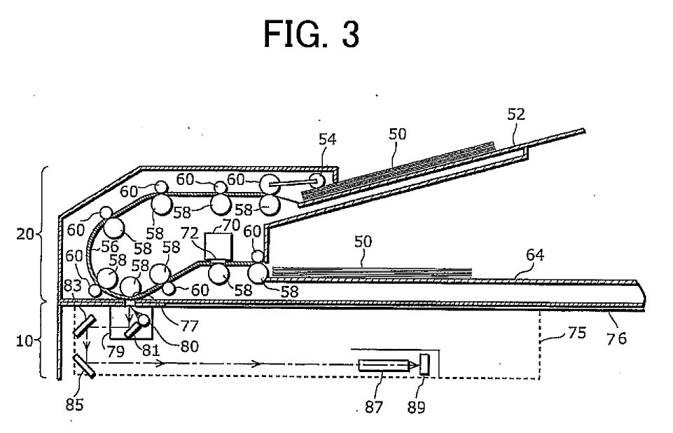

FIG. 3 is a cross sectional view showing the main parts of the scanner of the present embodiment. The scanner is configured by the ADF unit 20 and the FBS unit 10 as described above.

The ADF unit 20 includes an ADF and a back side scanning part 70. The ADF includes a document supply tray 52, transport rollers 54, 58, and 60, and a document discharge tray 64. The back side scanning part 70 scans an image contained on the back side of each document transported by the ADF.

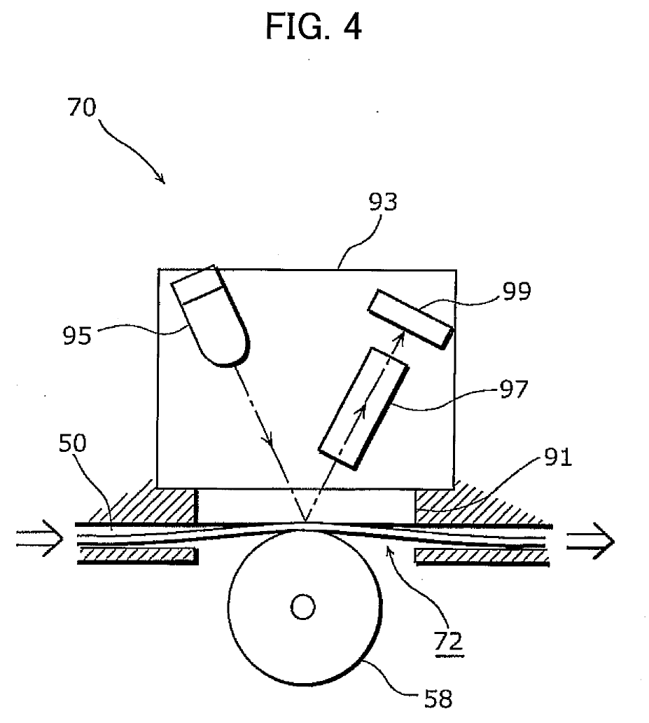

FIG. 4 is a view showing details of the back side scanning part 70 of the present embodiment. The back side scanning part 70 scans the image with a 100% magnification optical system. The back side scanning part 70 uses a contact-type sensor and includes a housing 93 and a translucent contact glass 91 attached thereto. The housing 93 includes a light source 95 arranged on a line, and a photoelectric transducer 99 for receiving reflected light from the document 50 passing through a back side scan slit 72 of a transportation path through an optical lens 97. The photoelectric transducer 99 of the present embodiment may be a CMOS (Complementary Metal Oxide Semiconductor) image sensor or the like. The photoelectric transducer 99 of the back side scanning part 70 may be a CCD (Charge Couple Device) image sensor.

The description now returns to FIG. 3.

The FBS unit 10 includes an FBS. The FBS includes a front side scanning part 75 and a contact glass 76. The front side scanning part 75 includes a scan part 79, mirrors 83 and 85, an optical lens 87, and a photoelectric transducer 89. The scan part 79 includes a light source 80 and a mirror 81. Specific examples of the light source 80 include an LED (Light Emitting Diode). Specific examples of the photoelectric transducer 89 include a CCD image sensor.

The operation of each unit when scanning a document with the scanner will be described below.

The scan part 79 scans a document placed on the contact glass 76 by moving towards the right in the figure by means of a drive device (not illustrated) while the light source 80 is emitting light. The reflected light from the document during the operation is received by the photoelectric transducer 89 through the mirror 81 and the mirrors 83 and 85, and output as electronic data. The mirrors 83 and 85 are moved towards the right in the figure by means of a drive device (not illustrated) at a speed different from the scan part 79 so that the distance from the mirror 81 to the photoelectric transducer 89 is constant. The scan part 79 and the mirrors 83 and 85 return to the initial position after scanning the document. The image on a document surface contacting the contact glass 76 is thereby scanned.

The movement of each document 50 and the flow of scanning the document 50 when scanning both sides of a plurality of documents 50 placed on the document supply tray 52 is now described.

Each document 50 placed on the document supply tray 52 starts to be transported by the roller 54, and is transported by a plurality of rollers 58 and 60 arranged on the sides of a transportation path 56 through which each document 50 passes. In the middle of transportation, the back side of document 50 is scanned by the back side scanning part 70 at the back side scan slit 72, and the front side of document 50 is scanned by the front side scanning part 75 at a front side scan slit 77.

Thus, the front side and the back side of the document passing through the transportation path are scanned with different scanning parts in the scanner of the present embodiment. The scanning of both sides is thus completed by simply passing through the transportation path once.

When scanning both sides, the image on the front side is scanned before the image on the back side. As described herein, a determination result is obtained faster by determining whether or not a specific image is contained in a document based on an image on the front side that is scanned first, rather than by determining whether or not the specific image is contained in the document based on an image on the back side that is scanned later. Since the start of processing, which starts after waiting for the determination result, becomes earlier, the entire processing can be terminated earlier.

The front side of the document corresponds to “second side of document” and the back side of the document corresponds to “first side of document” in the claims.

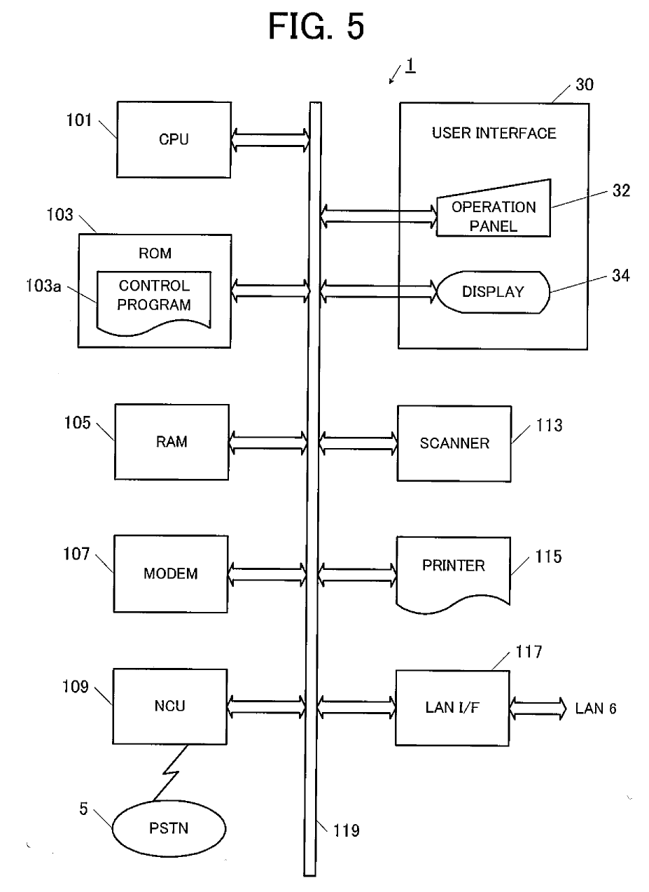

FIG. 5 is a view showing one example of a hardware configuration of the network multifunction peripheral 1 of the present embodiment. One example of the hardware configuration of the network multifunction peripheral 1 is shown.

The network multifunction peripheral 1 includes the user interface 30, a CPU 101, a ROM 103, a RAM 105, a modem 107, an NCU 109, a scanner 113, a printer 115, and a LAN I/F 117, which are connected by an internal bus 119.

The user interface 30 includes the operation panel 32 and the display 34. The operation panel 32 accepts operation from a user, and is specifically, a key button, a touch panel, and the like. The display 34 displays the operation guide and operation state of the network multifunction peripheral 1 to the user, and is specifically, an LCD (Liquid Crystal Display) and the like.

The CPU 101 executes a control program 103a stored in the ROM 103 and controls the entire network multifunction peripheral 1. The CPU 101 performs a control such that when a document containing the specific image is scanned as a characteristic process of the present invention, the image of the document is not output or transmitted as it is as electronic data or the image of the document is not printed as it is.

The ROM 103 is a read-only memory for holding the control program 103a to be executed by the CPU 101. The RAM 105 is a readable/writable memory for holding work data used when the CPU 101 executes the control program 130a, and electronic data obtained from the scanner 113.

The modem 107 modulates the electronic data held in the RAM 105 to a facsimile signal and transmits the signal, or demodulates the facsimile signal received from the outside to electronic data. The modem 107 is a fax mode complying with the G3 standard and the like.

The NCU 109 is a network control device for controlling the connection between the modem 107 and the PSTN 5.

The scanner 113 scans the image, and is one example of an image scanning device for scanning the image on both sides of a document with different scanning parts and determining whether or not the specific image is contained in the scanned images.

The scanner 113 supplies a plurality of documents placed on the document supply tray 52, in order, and under the control of the CPU 101 that executes the control program 103a stored in the ROM 103, scans the supplied document, and stores the scanned information in the RAM 105 as electronic data. The scanner 113 determines whether or not the specific image is contained in the scanned image, and compresses the scanned image. The functions of determining whether or not the specific image is contained in the scanned image and compressing the scanned image are respectively realized by one or a plurality of circuit substrates.

The printer 115 prints out the electronic data indicating each document stored in the RAM 105 as a document image under the control of the CPU 101.

The LAN I/F 117 is a communication adapter for connecting the network multifunction peripheral 1 and the LAN 6, and, for example, transmits the electronic data containing each document obtained by the scanner 113 to the terminal 3 etc. under the control of the CPU 101.

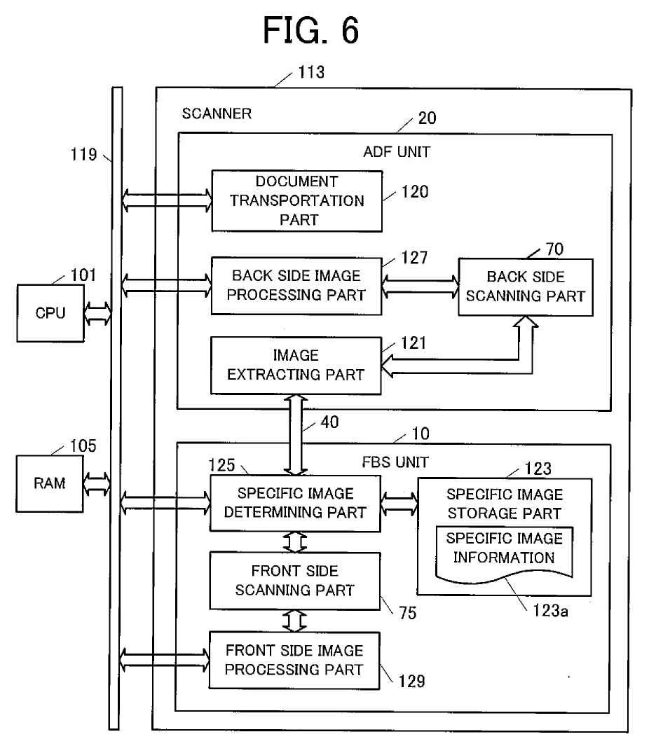

FIG. 6 is a block diagram showing a functional configuration of the scanner 113 of the present embodiment. In FIG. 6, the details of the scanner 113, and the CPU 101 and the RAM 105, which are particularly related to the scanner 113 out of the units shown in FIG. 5, and the internal bus 119 are shown.

The scanner 113 includes the ADF unit 20 having the back side scanning part 70, a document transportation part 120, a back side image processing part 127, and an image extracting part 121; and includes the FBS unit 10 having the front side scanning part 75, a specific image storage part 123, a specific image determining part 125, and a front side image processing part 129.

First, each part in the ADF unit 20 is described. 083 The document transportation part 120 supplies, in order, a plurality of documents placed on the document supply try 52 under the control of the CPU 101 that executes the control program 103a. Specifically, the document transportation part 120 is the ADF realized by a motor etc. for driving the rollers 54, 58, and 60 and the rollers 54 and 58, and corresponds to the document supply part in the claims.

The back side scanning part 70 scans the back side image information indicating the image on the back side when scanning both sides of a document supplied by the ADF, and corresponds to a first image scanning part in the claims. The back side scanning part 70 has already been described, and thus detailed description is omitted here.

The back side image processing part 127 performs image processing on the image information indicating the image on the back side of the document scanned by the back side scanning part 70, and compresses the image information. Methods of compressing the image information include a JPEG (Joint Photographic Experts Group) method and image compression method to GIF (Graphics Interchange Format) file.

The image extracting part 121 acquires the back side image information from the back side scanning part 70 and extracts specific component information out of information indicating the pixel value contained in the back side image information by referencing the acquired back side image information, and corresponds to an extracting part in the claims.

Specific component information is information indicating a specific component of the pixel value in each pixel contained in the image information acquired by the image extracting part 121.

In the present embodiment, the back side image information contains all the RGB components of each pixel contained in the image on the back side scanned by the back side scanning part 70, and the image extracting part 121 extracts only the R component of the RGB components contained in the back side image information. The specific component information of the present embodiment is the information indicating the value of R component in each pixel contained in the back side image information. A case where the image information is represented with the RGB component is also referred to as representing in “RGB system”.

The extraction of a specific component is realized by storing a format of the image information on what order each component for every pixel is contained in the image information in the image extracting part 121. That is, the image extracting part 121 references the back side image information and extracts information corresponding to the specific component according to the format of the image information.

Each part in the FBS unit 10 is now described.

The front side scanning part 75 scans the front side image information indicating the image on the front side when scanning both sides of a document supplied by the ADF, and corresponds to a second image scanning part in the claims. The front side scanning part 75 has already been described, and thus detailed description is omitted here. In the present embodiment, the resolution capabilities of the front side scanning part 75 and the back side scanning part 70 are the same.

The front side image processing part 129 performs image processing on the image information indicating the image on the front side of the document scanned by the front side scanning part 75, and compresses the image information. The method of compressing the image information includes the JPEG (Joint Photographic Experts Group) method and image compression method to GIF (Graphics Interchange Format) file.

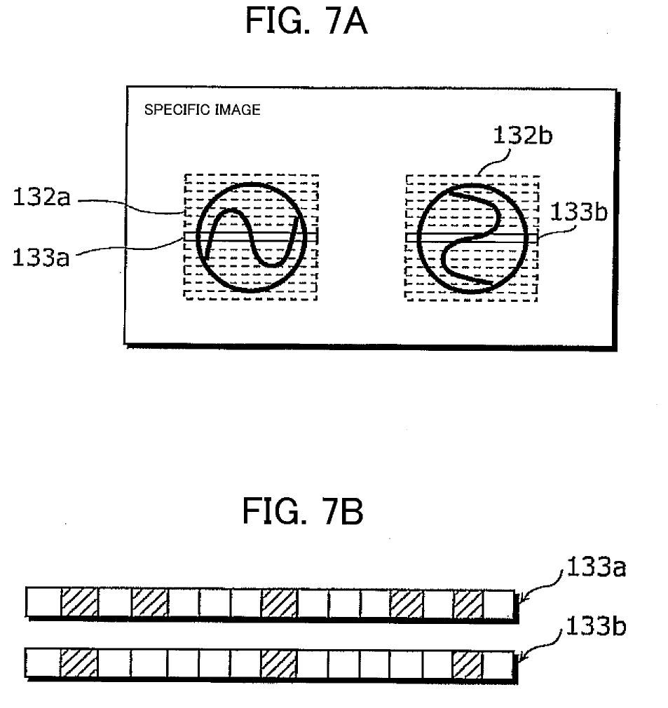

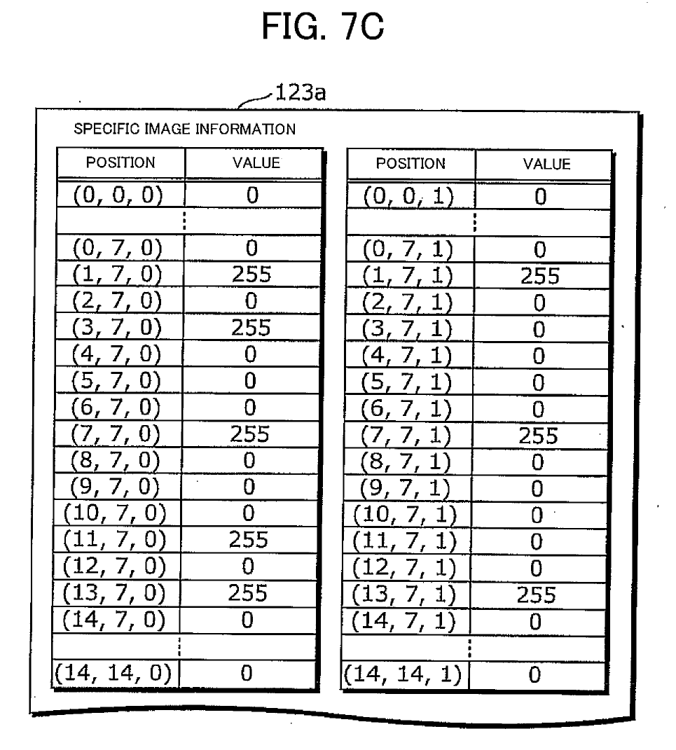

The specific image storage part 123 stores the specific image information 123a containing a value indicating a feature of the specific image, and corresponds to a specific image information storage part in the claims. The specific image information 123a of the present embodiment includes a value of a specific color component of each pixel value contained in a specific region or one part of the specific image as a value indicating the feature of the specific image. The specific image information 123a is more specifically described with reference to FIG. 7.

FIG. 7A is a view showing the specific image of the present embodiment. The specific image of the present embodiment is an image within a rectangular region surrounded with a dotted line frame 132a in the figure, and includes fifteen pixels horizontally and vertically. The image within the rectangular region surrounded by a dotted line frame 132b is an image of the image within the rectangular region surrounded by the dotted line frame 132a rotated by 90 degrees. Thus, whether or not the specific image is contained can be determined even if the document containing the specific image is rotated and then scanned by also storing information of the image after rotation.

FIG. 7B is a conceptual view describing one example of the specific image information 123a stored in the specific image storage part 123 of the present embodiment, and shows the seventh line of the specific image shown with solid line frames 133a and 133b for every pixel. The shaded area shows the portions where an R component of the pixel value of the image contained in the specific image is present.

FIG. 7C is a view showing one example of the specific image information 123a stored in the specific image storage part 123 of the present embodiment.

The specific image information 123a shown in FIG. 7C includes position and value. Regarding the position, the first component indicates an X coordinate position, the second component indicates a Y coordinate position, and the third component indicates either before rotation or after rotation. More specifically, 0 to 14 are given in order from the left as the X coordinate position in the first component. 0 to 14 are given in order from the top as the Y coordinate position in the second component. Furthermore, “0” is given to the image before rotation and “1” is given to the image after rotation in the third component. The value is the value of the R component contained in the pixel value corresponding to each position.

The specific image information 123a shown in FIG. 7C shows an example of including the specific image information where the value of position “(0, 0, 0)” is “0”, and the value of position “(1, 7, 0)” is “255”.

Description now returns to FIG. 6.

The wiring 40 is a wire connection for connecting the image extracting part 121 and the specific image determining part 125 to transmit the information extracted by the image extracting part 121. Specifically, the wiring 40 is a harness etc. for connecting a circuit substrate of the image extracting part 121 and a circuit substrate of the specific image determining part 125.

In the present embodiment, the image extracting part 121 extracts only the R component from the back side image information. Thus, the wiring 40 is a wiring for transmitting information of eight bits, and is configured by eight signal lines.

The wirings for connecting the CPU 101 and the document transportation part 120 and the back side image processing part 127 in the ADF unit 20 are directly connected to the internal bus 119, and are independent from the wiring 40 connecting the image extracting part 121 and the specific image determining part 125.

The modem 107, the printer 115, and the like are controlled by the CPU 101 through the internal bus 119. The control of the modem 107, the printer 115, and the like through the internal bus 119 delays when the internal bus 119 is occupied by the image information transmitted/received for determination of the specific image. Since the wiring 40 is independent from the internal bus 119, the influence on the internal bus by the image information transmitted/received for determination of the specific image is eliminated, and influence of the specific image determining process on other controls through the internal bus 119 is reduced.

The specific image determining part 125 determines whether or not the specific image is contained in the images on the front side and the back side.

In other words, the specific image determining part 125 acquires the specific component information, which is one part of the back side image information extracted by the image extracting part 121, from the image extracting part 121 through the wiring 40, acquires the specific image information 123a stored in the specific image storage part 123, compares a value indicating the feature of the image contained on the back side of the document obtained from the acquired specific component information with a value indicating the feature of the specific image contained in the acquired specific image information 123a, and determines that the specific image is contained in the back side when the difference between the two feature quantities is within a range defined in advance.

Furthermore, the specific image determining part 125 acquires the front side image information scanned by the front side scanning part 75 from the front side scanning part 75, compares a value indicating the feature of the image contained on the front side of the document obtained from the acquired front side image information with a value indicating the feature of the specific image contained in the acquired specific image information 123a, and determines that the specific image is contained on the front side when the difference between the two feature quantities is within the range defined in advance.

The specific image determining part 125 is desirably included only in one of the ADF unit 20 or the FBS unit 10 instead of being included in both the ADF unit 20 and the FBS unit 10 to reduce the cost per network multifunction peripheral and to reduce the cause of failure. Thus, only one specific image determining part 125 is included in the present embodiment.

The specific image determining part 125 of the present embodiment is included in the FBS unit 10. The specific image determining part 125 is connected with the image extracting part 121 by way of the wiring 40 to acquire the back side image information scanned by the back side scanning part 70 in the ADF unit 20.

In the present embodiment, only eight signal lines are enough for the wiring 40 since only one part of the back side image information is extracted by the image extracting part 121. That is, the number of wirings necessary for transmitting all the information of the RGB system or the YCC system is twenty-four, but the number of signal lines in the wiring 40 of the present embodiment can be less. With this small number of signal lines, the restriction and the load in design for arranging the wiring between the ADF unit 20 and the FBS unit 10 is alleviated. Furthermore, radiation noise is reduced as the number of signal lines is reduced.

Generally, an internal bus connection wiring, which is a common wiring, is used as the wiring for connecting the document transportation part 120 and the internal bus 119 and the wiring for connecting the back side image processing part 127 and the internal bus 119. If the CPU is sixteen bits, the internal bus connection wiring is configured by sixteen signal lines for transmitting the signal.

The wiring 40 is provided separate from the internal bus connection wiring. This prevents the internal bus connection wiring and the internal bus 119 from being occupied by the transmission of the back side image information from the back side scanning part 70 to the specific image determining part 125, thereby preventing delays in processing from occurring.

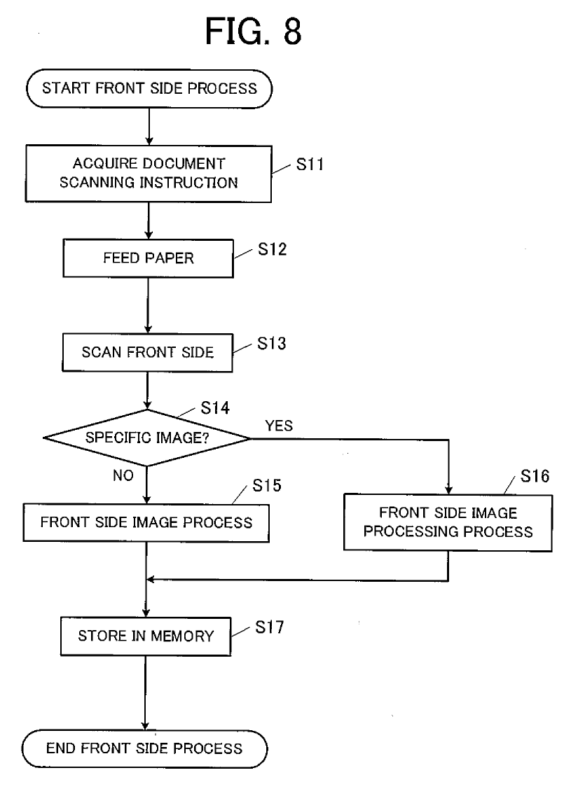

FIG. 8 is a flowchart of a front side process executed by the image scanning device of the present invention. In the description of FIG. 8, the CPU 101 executes the control program 103a stored in the ROM 103, and controls each unit according to the control program 103a.

The CPU 101 acquires an instruction of document scanning from user input to the operation panel 32 (S11).

The document transportation part 120 rotates the rollers 54 and 58 based on information from a sensor group detecting the document transported through the transportation path under the control of the CPU 101, and supplies the document 50 placed on the document supply tray 52 (S12).

The front side scanning part 75 scans the image on the front side of the document passing through the transportation path 56 (S13).

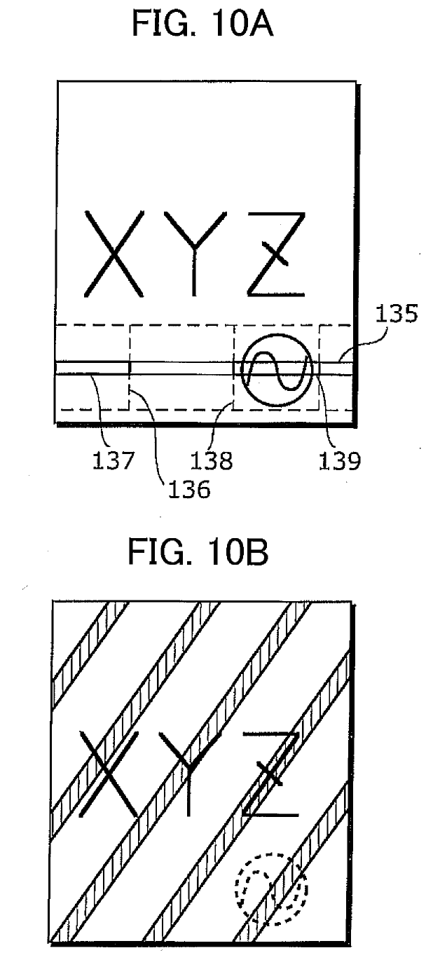

The specific image determining part 125 acquires the front side image information indicating the image on the front side scanned by the front side scanning part 75, and determines whether or not the specific image stored in the specific image storage part 123 is contained in the image indicated by the front side image information (S14). 117) Specific procedures of the process (S14) for determining whether or not the specific image is contained are described below with reference to FIG. 10A.

FIG. 10A is a view showing one example of the document containing the specific image. The specific image is the image shown in FIG. 7A, and the specific image information 123a is the content shown in FIG. 7C. The specific image is contained at the lower right on the front side of the document as shown in FIG. 10A.

The specific image determining part 125 acquires the front side image information indicating the image of the document shown in FIG. 10A from the front side scanning part 75, and acquires the specific image information 123a stored in the specific image storage part 123.

The specific image determining part 125 then compares the pixel value for fifteen continuous pixels contained in each line of the fifteen lines continuing in order from the top of the acquired front side image information with the pixel value for fifteen continuous pixels contained in each line configuring the acquired specific image information 123a. The fifteen lines and fifteen pixels correspond to the size of the specific image.

In other words, the R component of the pixel value of a constant number of continuous pixels contained in each row is used as the feature quantity of the image for determining whether or not the specific image is contained in the present embodiment. Furthermore, the specific image determining part 125 of the present embodiment determines whether the acquired information is the information corresponding to the front side of the document or the information corresponding to the back side of the document, and extracts the R component if determined that the information is the information corresponding to the front side of the document.

The procedure for the specific image determining part 125 to determine whether the acquired information is the front side image information or the one part of the back side image information is now described.

In the present embodiment, whether the acquired information is the front side image information or the back side image information is determined with the amount of information contained in each image information. The front side image information contains all the RGB components, whereas the back side image information contains only the R component, and thus the amount of information of the front side image information is greater than the amount of information of the back side image information. Therefore, the determination can be realized by storing the threshold value corresponding to the size of the document to be scanned.

Specifically, the front side image information output from the front side scanning part 75 contains information indicating the size of the scanned document, and the back side image information output from the back side scanning part 70 contains information indicating the size of the scanned document. The image extracting part 121 hands over the information indicating the size of the document contained in the back side image information to the specific image determining part 125. The specific image determining part 125 compares the threshold value corresponding to the size of the document contained in the acquired information with the amount of information of the acquired information.

Here, the acquired information is the front side image information or one part of the back side image information.

The specific image determining part 125 determines that the image information is the front side image information if the amount of information contained in the acquired information is greater than the threshold value, and the image information is the back side image information if the amount of information contained in the acquired information is the same as or smaller than the threshold value.

A flag indicating that the front side image information and the back side image information are image information corresponding to the front side of the document and the back side of the document, respectively, is contained in the front side image information and the back side image information in advance, where the image extracting part 121 references the flag to determine whether the image information is the front side image information or the back side image information.

The description now returns to the process (S14) for determining whether or not the specific image is contained.

In the present embodiment, the specific image determining part 125 calculates a difference absolute value sum of the pixel values of fifteen vertical lines and fifteen horizontal pixels of the front side image and the pixel values of the pixels at the corresponding positions contained in the specific image as a result of comparison, and determines whether or not the specific image is contained according to whether or not the calculated difference absolute value sum is less than or equal to the threshold value defined in advance.

In other words, the specific image determining part 125 determines that the specific image is not contained (No in S14) if the calculated difference absolute value sum is greater than the threshold value, and determines that the specific image is contained (Yes in S14) if the difference absolute value sum is less than or equal to the threshold value.

One example of a comparison of the pixel value for one line is described with reference to FIGS. 7 and 10A. A first image region 136 shown in FIG. 10A is the portion surrounded with a dotted line at the lower left, and a second image region is a portion 138 surrounded with a dotted line at the lower right. The first image region and the second image region both have an image region of fifteen vertical lines and fifteen horizontal pixels. A first line 137 is a pixel for the seventh row contained in the first image region 136, and the second line 139 is the pixel of the seventh row contained in the second image region 138. The first line 137 and the second line 139 are one part of a common line 135.

The specific image determining part 125 compares the pixel values of fifteen pixels continuing in the left and right direction contained in the corresponding front side image with the pixel values contained in the specific image information 123a. If all the pixel values of the pixels contained in the first line 137 are “0”, the difference absolute value sum of the seventh row obtained as a result of comparison is “1275”(=0×10+255×5)

If the pixel values of the pixels contained in the second line 139 are “10, 245, 0, 255, 0, 0, 0, 255, 0, 0, 0, 255, 0, 255, 0” in order from the left, the difference absolute value sum of the seventh row obtained as a result of comparison is “20”.

Therefore, the specific image determining part 125 determines that the specific image is contained on the front side of the document shown in FIG. 10A (Yes in S14) since the specific image is contained in the second line 139, which is one part of the front side image.

The difference absolute value sum is similarly calculated for the pixel values from the first line to the sixth line and from the eighth line to the fifteenth line of each image region, and the difference absolute value sums from the first row to the fifteenth row are added up so that the specific image determining part 125 can calculate the difference absolute value sum related to the determination on whether or not the specific image is contained.

The description will now return to FIG. 8.

If determined that the specific image is not contained (No in S14), the front side image processing part 129 acquires the front side image information from the front side scanning part 75 under the control of the CPU 101 that has acquired the determination result of the specific image determining part 125, and compresses the acquired front side image information as it is (S15).

If determined that the specific image is contained (Yes in S14), the front side image processing part 129 acquires the front side image information from the front side scanning part 75 under the control of the CPU 101 that has acquired the determination result of the specific image determining part 125, and compresses the acquired front side image information after performing processes (S16). An example of the processes performed on the document containing the specific image are described with reference to FIG. 10B.

FIG. 10B is a view showing one example of a copy of the document containing the specific image created by the network multifunction peripheral equipped with the image scanning device of the present invention. Shades of diagonal lines are created over the entire document, and the specific image contained in the document is slightly shaded off. Through such processes, use of copies can be prevented even if copies of the document containing the specific image are printed.

The front side image processing part 129 stores the image information compressed in the front side image process (S15) or the front side image processing process (S16) in the RAM 105 under the control of the CPU 101 (S17), and terminates the front side process.

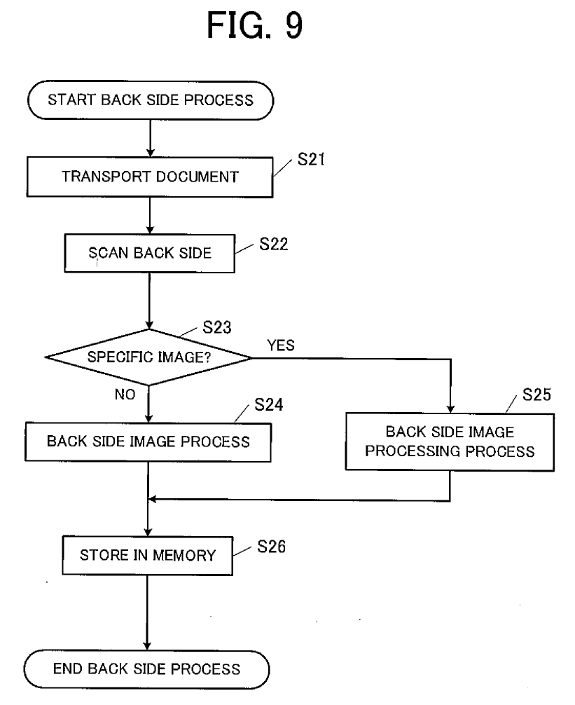

FIG. 9 is a flowchart of the back side process executed by the image scanning device of the present invention. In the description of the figure, the CPU 101 executes the control program 103a stored in the ROM 103, and controls each unit according to the control program 103a.

The process following the front side scan process (S13) of the front side process described with reference to FIG. 8 and the process following a back side scan process (S22) of the back side process to be described with reference to FIG. 9 are executed in parallel. The processing speed on the scanning of both sides of the document can be improved by such parallel processing.

The document transportation part 120 continues to transport the document 50 (S21), and the back side scanning part 70 scans the image on the back side of the document passing through the transportation path (S22).

The image extracting part 121 extracts specific component information from the back side image information indicating the back side image scanned by the back side scanning part 70, and the specific image determining part 125 acquires the specific component information through the wiring 40, and determines whether or not the specific image stored in the specific image storage part 123 is contained in the image indicating the back side image information (S23). The detailed determining method is similar to the specific image determination process (S14) of the front side image. Thus, the details of the determination process (S23) are omitted.

If determined that the specific image is not contained (No in S23), the back side image processing part 127 acquires the back side image information from the back side scanning part 70 under the control of the CPU 101 that has acquired the determination result of the specific image determining part 125, and compresses the acquired back side image information as it is (S24).

If determined that the specific image is contained (Yes in S23), the back side image processing part 127 acquires the back side image information from the back side scanning part 70 under the control of the CPU 101 that has acquired the determination result of the specific image determining part 125, and compresses the acquired back side image information after performing processes (S25). An example of the processes on the document containing the specific image is similar to that on the image on the front side described with reference to FIG 10B, and thus the description thereof is omitted.

The back side image processing part 127 stores the image information compressed in the back side image process (S24) or the back side image processing process (S25) in the RAM 105 under the control of the CPU 101 (S26), and terminates the process.

The process executed by the scanner 113 has been described with reference to FIGS. 8 and 9. The scanner of the present embodiment can determine whether or not the specific image is contained on both images on the front side and the back side with one specific image determining part 125. The specific image determining part can determine whether or not the specific image is contained with only the R component, that is, with only one part of the image information.

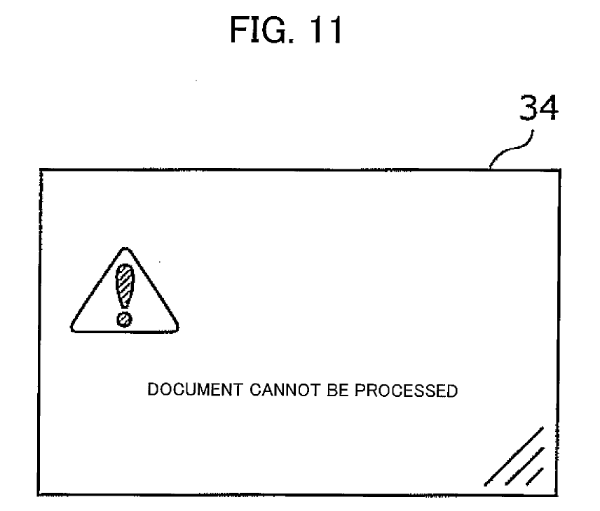

An example of presenting the result determined by the above process to the user is shown in FIG. 11.

FIG. 11 is a view showing a display example of the display 34 for presenting that the specific image is contained in the scanned document. As shown in FIG. 11, if the specific image is contained in the document, a display is provided on the display 34 that the specific image is contained in the scanned document by the CPU 101 that has acquired the determination result of the specific image determining part 125. The user can then know that the processing process shown in FIG. 10B is performed on the output image because the specific image is contained in the document.

The image scanning device according to an embodiment of the present invention has been described above, but the present invention is not limited to this embodiment.

For instance, while the specific image determining part 125 is described as included in the FBS unit 10 in the embodiment, it may be included in the ADF unit 20 instead of the FBS unit 10. In this case, the image extracting part is included in the FBS unit 10, one part of the front side image information scanned by the front side scanning part is extracted by the image extracting part, and the information extracted by the image extracting part is transmitted to the specific image determining part from the image extracting part through the wiring. Therefore, similar to the embodiment, the number of signal lines configuring the wiring is reduced, and the restriction and the load in design thus are alleviated.

The specific image determining part 125 may use a histogram to determine whether or not the specific image is contained in the document. The term “histogram” used herein is a histogram showing distribution of pixel values of each pixel contained in the image. A case where the pixel value is represented with RGB component is described by way of example.

The specific image storage part 123 stores the histogram of the R component contained in the specific image as the specific image information 123a.

The specific image determining part 125 compares the histogram of the. R component of each region corresponding to the size of the specific image contained in the document with the specific image information 123a, and compares the difference between the above two with the threshold value as a result of comparison. Whether or not the specific image is contained in the document is then determined.

The specific image information 123a may not be the R component of the pixel value of the pixel configuring the specific image, and may instead be the G component or the B component.

In the present embodiment, while the back side image information is described as being represented in the RGB system, it may instead be represented with luminance/color difference component. In this case, the specific color component is calculated from the luminance and the color difference, and only the specific color component is extracted in this case as well, similar to the embodiment. Representing the image information with the luminance/color difference component is referred to below as representing in the “YCC system”. The back side image information may also be represented with brightness/chroma component. Representing the back side image information with the brightness/chroma component is referred to below as representing in the “Lab system”.

The image extracting part 121 may extract one of the luminance or the two color differences contained in the back side image information regardless of whether the back side image information is the RGB system, the YCC system, or the Lab system. If the back side image information indicates the image on the back side with the kGB component, the image extracting part 121 extracts the information defined in advance by calculating one of the luminance or the two color differences defined in advance as information to be extracted.

The specific image information may be the R component of the pixel value contained not only in one line of the specific image but contained in the pixels of a plurality of lines. In this case, the specific image determining part compares the pixel values of the pixels contained in the corresponding plural lines, and makes the determination. More specifically, the difference absolute value sum of the pixel value of each pixel at the corresponding position is compared with the threshold value, and determination is made that the specific image is not contained if the difference absolute value sum is larger than the threshold value, and determination is made that the specific image is contained if the difference absolute value sum is smaller than or equal to the threshold value. Whether or not the specific image is contained can thus be determined using the pixels contained in the plurality of lines, whereby the accuracy of determination is enhanced.

While the resolution capabilities of the front side scanning part 75 and the back side scanning part 70 are described as being the same in the embodiment, the resolution capabilities of the front and back side scanning parts may be different. If the resolution of the front side scanning part is higher than that of the back side scanning part, and determination on the specific image is made with the specific image information common to both sides, the specific image information contains the pixel value of the number of pixels corresponding to the resolution capability of the back side scanning part 70. Thus the front side scanned information output from the front side scanning part 75 is input to the specific image determining part after being subjected with complementary process or decimation process at one part so as to obtain the number of pixels contained in the specific image information.

Moreover, the specific image storage part 123 of the present embodiment stores the specific image information 123a common to the front side and the back side as the specific image information 123a, and the specific image determining part references the relevant specific image information 123a to determine whether the specific image is contained in either side, but the specific image information may be different for the front side and the back side.

First, the specific image information for the front side may contain not only the specific component but also all the image information of the specific image. In this case, the specific image determining part makes the determination on the back side image with the method similar to the embodiment. With respect to the front side image, the specific image determining part compares the difference absolute value of each component of the pixel value of each pixel contained in the front side image information and the specific image with the threshold value, and determines that the specific image is not contained if the difference absolute value is greater than the threshold value and determines that the specific image is contained if the difference absolute value is less than or equal to the threshold value as a result of the comparison. A determination of higher accuracy can be made on the front side image.

The specific image information for the front side may contain information indicating the pixel value of a greater number of pixels than the specific image information for the back side. Suppose the pixel value of the pixel contained in the specific region of the same image is the specific image information, the number of pixels contained in the specific image information will differ if the resolution capability differs between the front side scanning part and the back side scanning part. That is, if the resolution capability of the front side scanning part is higher than that of the back side scanning part, the number of pixels contained in the specific image information for the front side is greater than the number of pixels contained in the specific image information for the back side. Thus, an accurate determination of the specific image can be made according to the resolution capability by separately using the specific image information for the front side and the image information for the back side according to the, respective resolution capabilities of the front and back side scanning parts.

Moreover, in the present embodiment, the specific image determining part 125 determines whether the acquired information is the front side image information or one part of the back side image information based on the amount of information contained in the acquired information, but the determination method is not limited thereto. Specifically, flag information indicating as being the image on the front side may be contained in the front side image information by the front side scanning part 75, and flag information indicating as being the image on the back side may be contained in the back side image information by the back side scanning part 70. In this case, the image extracting part 121 hands over one part of the back side image information including the flag information indicating as being the image on the back side to the specific image determining part 125, so that the specific image determining part 125 can reference the flag information contained in the acquired information and determine whether the acquired information is the front side image information or one part of the back side image information.

In the present embodiment, the front side image information is directly handed over from the front side scanning part 75 to the specific image determining part 125 without passing through the image extracting part, but may be handed over to the specific image determining part 125 through the image extracting part after being scanned by the front side scanning part 75, similar to the back side image information of the present embodiment. That is, the specific image determining part 125 merely needs to acquire at least one part for the front side image information as opposed to acquiring only one part such as the specific color component for the back side image information. Thus, the wiring 40 for handing over the back side image information is the same as in the embodiment, that is, the wiring 40 is configured with a small number of wirings necessary for transmitting only one part of the image information. Whether or not the specific image is contained in each of the front side image and the back side image is determined based on information in which a similar extraction process is performed on the front side image information and the back side image information. Thus, the specific image determining part 125 can make the determination by performing a similar process on each of the front side image information and the back side image information, as opposed to a case of performing the extraction process only on the back side image information.

According to the variant described above, the back side image information scanned by the back side scanning part only has the specific component contained therein handed over to the specific image determining part, and thus the back side scanning part and the specific image determining part can be connected with the wiring configured by a smaller number of signal lines than in a case of handing over all the components.

The present invention is applicable to image scanning devices for scanning both sides of a document while passing through the document transportation path in the ADF once, and in particular, is applicable to a copy machine, a scanner, a FAX, and a multifunction peripheral thereof equipped with the image scanning device.

While the present invention has been described with respect to embodiments thereof, it will be apparent to those skilled in the art that the invention may be modified in numerous ways and may assume many embodiments other than those specifically set out and described above. Accordingly, the appended claims cover all modifications that fall within the true spirit and scope of the present invention.

What is claimed is:

1. An image scanning device for scanning an image of a document, and determining whether or not a specific image is contained in the scanned image; the image scanning device comprising:
a first scanning part for scanning an image on a first side of the document and outputting first image information indicating the scanned image;
an extracting part for acquiring the first image information from the first scanning part and referencing the acquired first image information to extract specific component information indicating a specific component of each pixel out of information indicating a pixel value contained in the first image information;
a specific image information storage part for storing specific image information for determining the specific image; and
a specific image determining part for acquiring the extracted specific component information from the extracting part and acquiring the specific image information from the specific image information storage part, and determining whether or not the specific image is contained in the image on the first side based on the acquired specific component information and the acquired specific image information.

2. The image scanning device according to claim 1, further comprising a second scanning part for scanning an image on a second side of the document and outputting second image information indicating the scanned image; wherein
the specific image determining part further acquires the second image information from the second scanning part, and determines whether the specific image is contained on the second side of the document based on the acquired second image information and the acquired specific image information.

3. The image scanning device according to claim 2, further comprising a document pressing unit attached to a body unit in a freely openable/closable manner, wherein
the document pressing unit includes the first scanning part and the extracting part; and
the body unit includes the specific image information storage part, the specific image determining part, and the second scanning part.

4. The image scanning device according to claim 3, further comprising a dedicated line for connecting the extracting part and the specific image determining part and transmitting the specific component information extracted by the extracting part.

5. The image scanning device according to claim 2, wherein the second scanning part has a higher resolution capability than the first scanning part.

6. The image scanning device according to claim 3, wherein the first scanning part performs scanning in a contact-type sensor method and the second scanning part performs scanning in an optical reduction method.

7. The image scanning device according to claim 2, wherein
the first image information and the second image information indicate a luminance of each color component of each pixel contained in a respective side of the document; and
the extracting part acquires the information indicating the luminance of one of the color components from the acquired first image information as the specific component information.

8. The image scanning device according to claim 2, wherein
the first image information and the second image information indicate luminance and each color difference contained in a respective side of the document; and
the extracting part acquires one of the information indicating the luminance and each color difference from the acquired first image information as the specific component information.

9. The image scanning device according to claim 2, wherein the first scanning part scans an image on the back side of the document and the second scanning parts scans an image on the front side of the document.

10. A network multifunction peripheral comprising a printer for printing information as characters or images, a facsimile communication unit for transmitting information in facsimile, a network communication unit for transmitting/receiving information with a device connected through a network, and a scanner including a document supply part for automatically supplying a document and an image scanning part for scanning images on both sides of the document supplied by the document supply part with different scanning parts and determining whether or not a specific image is contained in the scanned images; wherein
the image scanning part includes a first scanning part for scanning an image on a first side of the document and outputting first image information indicating the scanned image,
an extracting part for acquiring the first image information from the first scanning part and extracting specific component information, which is a specific component of the acquired first image information;
a specific image information storage part for storing specific image information for determining the specific image; and
a specific image determining part for acquiring the extracted specific component information from the extracting part and acquiring the specific image information from the specific image information storage part, and determining whether or not the specific image is contained in the image on the first side based on the acquired specific component information and the acquired specific image information.

11. A method of controlling an image scanning device for scanning an image of a document and determining whether or not a specific image is contained in the scanned image, the method comprising the steps of:
scanning an image on a first side of the document and outputting first image information indicating the scanned image;
acquiring the first image information from the first scanning part and referencing the acquired first image information to extract specific component information indicating a specific component of each pixel out of information indicating a pixel value contained in the first image information;
a specific image information storage part for storing specific image information for determining the specific image; and
acquiring the extracted specific component information from an extracting part and acquiring the specific image information from the specific image information storage part, and determining whether or not the specific image is contained in the image on the first side based on the acquired specific component information and the acquired specific image information.

12. The method of controlling the image scanning device according to claim 11, further comprising the step of:
scanning an image on a second side of the document and outputting second image information indicating the scanned image; wherein
the determining step further acquires the second image information from a second scanning part, and determines whether the specific image is contained on the second side of the document based on the acquired second image information and the acquired specific image information.

13. The method of controlling the image scanning device according to claim 12, wherein
the first image information and the second image information indicate a luminance of each color component of each pixel contained in a respective side of the document; and
the extracting step acquires the information indicating the luminance of one of the color components from the acquired first image information as the specific component information.

14. The method of controlling the image scanning device according to claim 12, wherein
the first image information and the second image information indicate luminance and each color difference contained in a respective side of the document; and
the extracting step acquires one of the information indicating the luminance and each color difference from the acquired first image information as the specific component information.

15. A method of controlling a network multifunction peripheral comprising the steps of:
printing information as characters or images;
transmitting information in facsimile;
transmitting/receiving information with a device connected through a network;
automatically supplying a document;
scanning images on both sides of the supplied document;
determining whether or not a specific image is contained in the scanned images;
scanning an image on a first side of the document and outputting first image information indicating the scanned image;
acquiring the first image information from a first scanning part and extracting specific component information, which is a specific component of the acquired first image information;
storing specific image information for determining the specific image;
acquiring the extracted specific component information from an extracting part and acquiring the specific image information from the specific image information storage part; and
determining whether or not the specific image is contained in the image on the first side based on the acquired specific component information and the acquired specific image information.

16. A digital storage medium having electronically readable control signals stored thereon and being adapted to cooperate with a programmable computing device such that a method of claim 15 is performed.
